(19) United States
(12) Patent Application Publication
(10) Pub. No.: US 2004/0040797 A1
(43) Pub. Date: Mar. 4, 2004

(54) Electromechanical aircraft brake system and method incorporating piezoelectric actuator subsystem

(76) Inventors: Leo W. Plude, Woodinville, WA (US); Robert F. Mackness, Marysville, WA (US)

Correspondence Address: HARNESS, DICKEY & PIERCE, P.L.C., P.O. BOX 828, BLOOMFIELD HILLS, MI, 48303, US

(21) Appl. No.: 10/231,745

(22) Filed: Aug. 30, 2002

(51) Int. Cl. F16D 65/36

(52) U.S. Cl. 188/156

(57) ABSTRACT

A brake system for use on a mobile platform such as a commercial aircraft. The brake system includes an electromechanical actuator (EMA) subsystem and a piezoelectric actuator subsystem. The EMA subsystem is used to urge a brake piston into contact with a pressure plate, and the pressure plate into contact with a brake rotor. The piezoelectric actuator subsystem is then used as a high frequency means to more effectively modulate the pressure plate into contact with the brake rotor to effect a braking action on the brake rotor. The invention allows smaller, less complex DC motors to be employed, that in turn results in significantly smaller wire bundles being needed on each wheel assembly of an aircraft where the invention is employed. The invention even more effectively modulates the pressure plate to better apply anti-skid braking signals to the brake rotor.

### FIELD OF THE INVENTION

The present invention relates to brake assemblies used on mobile platforms such as aircraft, and more particularly to a brake system incorporating an electromechanical subsystem for initially moving the braking elements of an aircraft brake assembly into contact with each other, in addition to the use of a piezoelectric subsystem for modulating the pressure applied to the braking elements to more closely control the braking action.

### BACKGROUND OF THE INVENTION

The use of electrical brake actuation means as a replacement for existing hydraulic actuation technology commonly used with braking systems for mobile platforms, and more particularly for aircraft, has been pursued for many years. The dominant approach has been to use several electric motors on each brake housing to apply the force and motion required to bring the brake friction elements into contact with each other. The relatively large amount of electrical power consumed by the electric motors typically requires bulky wire bundles to be installed on the landing gear of an aircraft. This is undesirable from the perspective of the weight involved, as well as the cost involved for the large and complex wire bundles. The use of large and bulky wire bundles can also contribute to landing gear noise because the wire bundles are exposed to the airstream during takeoff and landing of the aircraft.

Another drawback with the use of conventional electric motors for aircraft braking systems is the high power consumption of such motors. The high power consumption requires that an electrical power controller being used to control the motors be constructed in a manner sufficient to reject a significant degree of heat caused by the high power consumption.

Electric motor driven actuators furthermore generally have an inherently low frequency response. A braking system which is capable of modulating the friction (i.e., braking) elements at a higher frequency would be highly desirable to better respond to anti-skid braking control signals produced by a braking system used on a commercial aircraft. A braking system which provides a higher frequency response would provide an advantage over a strictly electromechanical type of braking assembly because of its ability to even more effectively apply an anti-skid braking action to an aircraft wheel.

### SUMMARY OF THE INVENTION

The above and other objects are provided by a braking system incorporating an electromechanical braking subsystem and a piezoelectric braking subsystem. The electromechanical braking subsystem is used to bring one or more braking elements into contact with one or more rotating elements of a brake assembly of a mobile platform, such as a brake rotor on an aircraft, during a braking sequence. Once the braking stationary elements are in reasonably close proximity to the rotating elements, the piezoelectric braking subsystem is modulated such that a piezoelectric element thereof controllably modulates the stationary braking elements contact with the rotating elements of the brake assembly of the mobile platform.

The use of an electromechanical braking subsystem and a piezoelectric braking subsystem provides several significant advantages over strictly electromechanical braking subsystems. For one, the electric motor used with the electromechanical braking subsystem can be significantly smaller in size and power rating since it is not required to produce high frequency response rates. Instead, it is required to only bring the stationary braking elements into close proximity to the rotating elements of the brake assembly. Thus, a much smaller and lightweight electric motor can be used than that required with previous braking systems that rely on the electric motor to modulate the braking element.

The use of a piezoelectric braking subsystem provides additional benefits over strictly electromechanical braking subsystems. The piezoelectric braking subsystem, with its piezoelectric element, provides an extremely fast-acting brake mechanism by which the brake elements can be modulated at an even higher frequency than what would be allowed by an electric motor. This allows even better modulation and control over the braking elements during anti-skid braking operation.

Further areas of applicability of the present invention will become apparent from the detailed description provided hereinafter. It should be understood that the detailed description and specific examples are intended for purposes of illustration only and are not intended to limited the scope of the invention.

### BRIEF DESCRIPTION OF THE DRAWINGS

The present invention will become more fully understood from the detailed description and the accompanying drawings, wherein:

FIG. 1 is a side view of a portion of a wheel/brake assembly of a commercial aircraft illustrating a quantity of braking systems in accordance with a preferred embodiment of the present invention being disposed circumferentially about the circumference of the wheel;

FIG. 2 is a schematic representation of one of the braking systems of the present invention shown in FIG. 1, with the system shown in a disengaged position relative to a brake rotor just prior to the beginning of a braking sequence; and

FIG. 3 is a simplified schematic representation of the braking system of FIG. 2 after the electromechanical braking subsystem has moved a pressure plate into close proximity to the brake rotor of the wheel;

### DETAILED DESCRIPTION OF THE PREFERRED EMBODIMENTS

The following description of the preferred embodiment(s) is merely exemplary in nature and is in no way intended to limit the invention, its application, or uses.

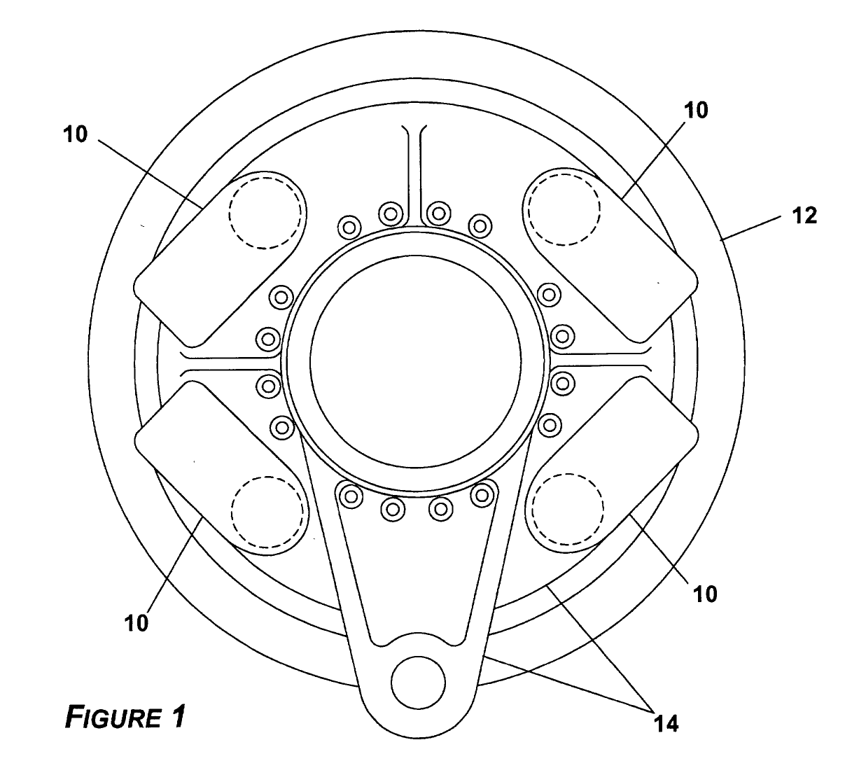

Referring to FIG. 1, there is shown a wheel assembly 12 and a brake frame 14 incorporating a plurality of braking systems 10 in accordance with a preferred embodiment of the present invention. The wheel 12 and brake frame 14 are illustrated as a single wheel/brake assembly of a commercial aircraft. However, it will be appreciated that the present invention can be used with virtually any form of mobile platform incorporating wheels that require a braking action in order to stop movement of the vehicle. FIG. 1 illustrates four working apparatuses 10 being disposed circumferentially about the brake frame 14. Again, however, it will be appreciated that a greater or lesser plurality of braking apparatuses 10 could be employed depending upon the size of the mobile platform, the degree of braking action required in order to bring the mobile platform to a stop within a given distance, the speed at which braking may begin to take place, the weight of the vehicle, as well as various other considerations. Essentially, however, each of the braking apparatuses 10 operate independently, but in unison, to quickly and effectively arrest rotational movement of the wheel of the mobile platform with which the apparatuses 10 are employed.

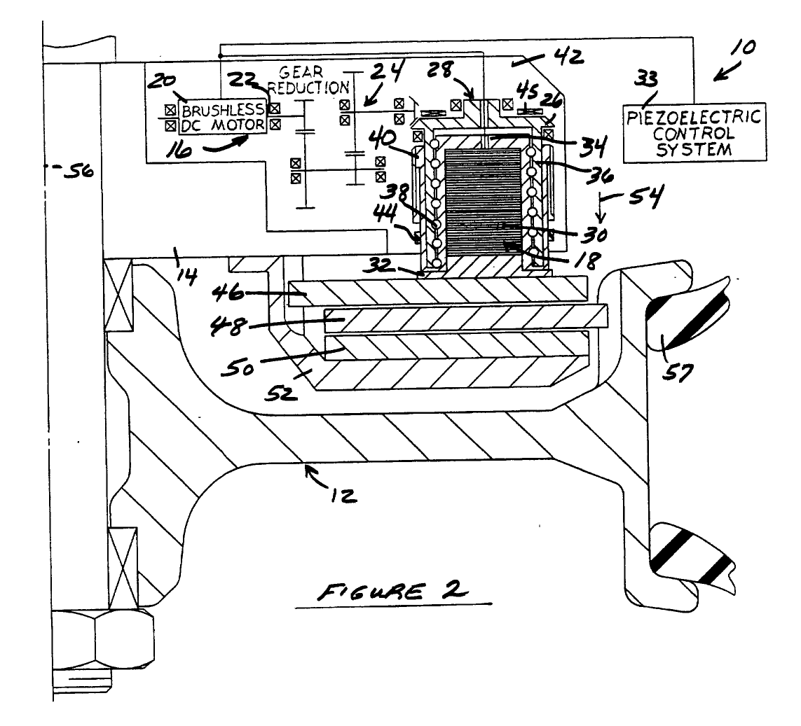

Turning to FIG. 2, a more detailed illustration of one of the apparatuses 10 is provided. The apparatus 10 generally comprises an electromechanical actuator subsystem 16 and a piezoelectric actuator subsystem 18. The electromechanical actuator subsystem 16 is formed by an electric motor, and in one preferred form a brushless DC electric motor 20, having an output shaft 22. The output shaft 22 is coupled to a gear reduction system 24 which is in turn engaged with a bevel gear 26 of a ball screw subassembly 28.

The piezoelectric actuator subsystem 18 is comprised of a piezoelectric element 30 which is in contact with a piston head 32. A piezoelectric control system 33 is used to modulate the piezoelectric element 30. The piezoelectric element 30 is disposed within a ball nut 34 of the ball screw assembly. The ball nut 34 comprises part of the electromechanical actuator subsystem 16 and is able to move linearly within a ball nut housing 36 by movement of a plurality of balls 38. The ball nut 34 is prevented from rotating by a spline 40.

The entire electromechanical actuator subsystem 16 is mounted on a piston housing 42. A seal 44, such as an O-ring seal 44, provides a seal between the piston housing 42 and the nut housing 36 of the ball screw subassembly 28. A thrust bearing 45 receives the thrust experienced by the ball screw subassembly 28. The piston head 32 is in contact with a pressure plate 46. The pressure plate 46 essentially functions as a braking element to apply pressure against a brake rotor 48 and to thereby effectively squeeze the brake rotor 48 between the pressure plate 46 and a backing plate 50. The pressure plate 46, brake rotor 50 and backing plate 48 are all housed within a torque tube 52 which is part of the brake frame 14. It will be appreciated that the torque tube 52, pressure plate 46, brake rotor 50 and backing plate 48 are all components of a conventional brake system presently employed on various commercial aircraft. Additional explanation of a braking system suitable for use with commercial aircraft can be found in U.S. Pat. Nos. 5,228,541 and 6,302,244, the disclosures of which are hereby incorporated by reference into the present application.

In operation, the electromechanical actuator subsystem 16 is used as a “long stroke” component to initially move the piston head 32 into close proximity to the pressure plate 46, and to take up the running clearance between the pressure plate 46, the rotor 48 and the backing plate 50. Preferably, the pressure plate 46 is moved just into contact with the brake rotor 48. This is accomplished by using DC motor 20 and gear reduction subsystem 24 to drive bevel gear 26. Driving bevel gear 26 rotationally causes linear translating movement of the ball nut 34 in the direction of arrow 54 in FIG. 2, thus bringing pressure plate 46 into close proximity with the brake rotor 48. It will be appreciated that brake rotor 48 will be rotating about an axle centerline 56. It will also be appreciated that if a plurality of the brake apparatuses 10 are employed, that the braking action described in connection with FIG. 2 will preferably be performed simultaneously for all of the apparatuses 10 mounted on the brake frame 14. A portion of a tire is denoted by reference numeral 57.

The piezoelectric element 30 preferably comprises a multilayer piezoelectric component comprising a plurality of secured together layers of piezoelectric elements. It will be appreciated, however, that a single piezoelectric layer of suitable length and thickness might be employed to meet the needs of a specific application.

By using the electromechanical actuator subsystem 16 only to move the pressure plate 46 into close proximity to the brake rotor 48, a much less complicated electromechanical actuator subsystem 16 can be employed. In practical terms, this results in wire bundles of significantly reduced size. A less complex electromechanical actuator subsystem, with a smaller motor, also reduces the cost associated with this portion of the braking apparatus 10.

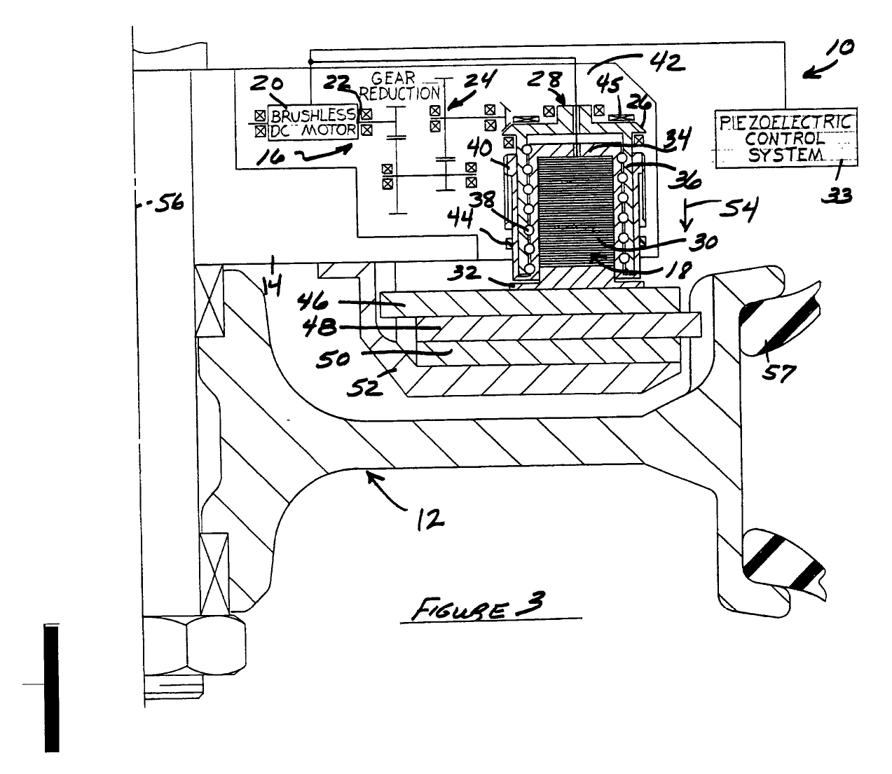

Referring to FIG. 3, after the pressure plate 46 has been moved into close proximity with the brake rotor 48, the piezoelectric element 30 is activated via a suitable signal from the piezoelectric control system 33. The electrical signal provided by the piezoelectric control system 33 causes the piezoelectric element 30 to move in accordance with the frequency of the electrical signal output from the system 33. This causes the pressure plate 46 to be modulated into contact with the brake rotor 48 at a desired frequency as needed to implement anti-skid braking operation.

The piezoelectric element 30 and its associated control system 33 thus function as a “small stroke”, high frequency means of applying the needed pressure to the pressure plate 46 to effect a braking action on the brake rotor 48. The electromechanical actuator subsystem 16 functions essentially as a means to take up the running clearance between the pressure plate 46 and the brake rotor 48, and thus to account for brake frame 14 and torque tube 52 component deflections and wear of the friction material associated with the pressure plate 46, brake rotor 48 and backing plate 50.

Another benefit of the present invention is that the piezoelectric element 30 functions to provide improved brake whirl vibration suppression. The use of a piezoelectric actuator 30 and an associated piezoelectric control system 33 allows easier detection of the onset of brake whirl and a ready means to quickly adjust the pressure distribution of the piezoelectric elements 30 of a plurality of brake apparatuses 10 being used on a given wheel assembly to better actively suppress this brake vibration mode.

The present invention thus provides a means to even more effectively provide a braking action to a wheel of a mobile platform. By incorporating piezoelectric actuator subsystem 18, much greater, high frequency control can be exerted over the mechanical elements of a braking system to even more effectively implement anti-skid braking operation. The use of piezoelectric technology also allows smaller, less complicated electromechanical actuator subassemblies to be employed, which thus in turn reduces the size and weight of the wire bundles used on wheel assemblies.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A brake apparatus for a mobile platform having a brake system including at least one rotor, said brake apparatus comprising:
an electromechanical brake subsystem for initially moving a braking element toward said rotor when said brake system is initially activated by an operator of said mobile platform; and
a piezoelectric brake subsystem for modulating said braking element after said braking element has been moved into close proximity to said rotor.

2. The brake apparatus of claim 1, wherein said electromechanical brake subsystem comprises an electric motor for initially urging said braking element toward said rotor.

3. The brake apparatus of claim 2, wherein said electric motor comprises a brushless direct current (DC) electric motor.

4. The brake apparatus of claim 1, wherein said piezoelectric brake subsystem comprises:
a piezoelectric element for modulating said braking element in response to an electrical signal; and
a housing for supporting said piezoelectric core.

5. The brake apparatus of claim 4, further comprising a control system for generating said electrical signal for said piezoelectric element.

6. The brake apparatus of claim 4, wherein said housing comprises a ball screw.

7. The brake apparatus of claim 6, wherein:
said electromechanical brake subsystem comprises an electric motor; and
a gear reduction subassembly interposed between said electric motor and said ball screw.

8. A brake apparatus for an aircraft having a brake system including at least one rotor, said brake apparatus comprising:
a first brake subsystem for initially moving a braking element toward said rotor when said brake system is initially activated; and
a second brake subsystem including a piezoelectric brake subsystem, said piezoelectric brake subsystem including a generally linearly moveable piezoelectric element for modulating said braking element after said braking element has been moved into close proximity to said rotor.

9. The brake apparatus of claim 8, wherein said first brake subsystem comprises an electromechanical brake subsystem.

10. The brake apparatus of claim 9, wherein said electromechanical brake subsystem comprises:
an electric motor;
a gear reduction subsystem operably coupled to an output shaft of said motor; and
a drive subassembly responsive to said gear reduction system for initially urging said braking element toward said rotor when said electromechanical brake subsystem is activated.

11. The brake apparatus of claim 10, wherein said drive subassembly comprises a ball screw assembly, said ball screw assembly including:
a housing;
a ball nut disposed within said housing and movable linearly in response to operation of said gear reduction subsystem; and
a piezoelectric element of said piezoelectric brake subsystem being disposed within said ball nut.

12. A brake apparatus for a mobile platform having a brake assembly, wherein the brake assembly includes a braking element movable into contact with a rotating element operably associated with a wheel of said mobile platform to thereby effect a braking action on said rotating element, said brake apparatus comprising:
a first braking subsystem comprising an electrical motor operably coupled to said braking element for initially moving said braking element toward said rotating element upon generation of a braking signal; and
a second braking subsystem for modulating said braking element into contact with said rotating element at a desired frequency.

13. The brake apparatus of claim 12, wherein said second braking subsystem comprises a piezoelectric braking subsystem.

14. The brake apparatus of claim 13, wherein said piezoelectric braking subsystem comprises a piezoelectric element operably coupled to said first braking subsystem.

15. The brake apparatus of claim 12, wherein said first braking subsystem comprises a direct current (DC) motor.

16. The brake apparatus of claim 12, wherein said first braking subsystem comprises a gear reduction subsystem operably coupled to an output shaft of said electric motor.

17. The brake apparatus of claim 12, wherein said first braking subsystem comprises a ball screw subassembly operably coupled to said electric motor.

18. A method of braking rotational movement of a wheel of a mobile platform, comprising:
using a first, electromechanical braking subsystem to initially move a braking element towards a rotating element associated with said wheel; and
using a second braking subsystem to controllably modulate said braking element into contact with said rotating element.

19. The method of claim 18, wherein using said second braking subsystem comprises using a piezoelectric actuator to modulate said braking element into contact with said rotating element.

20. The method of claim 18, wherein using a first electromechanical braking subsystem comprises using an electric motor to drive a ball nut, said ball nut carrying a component of said second braking subsystem.

21. A method of braking a wheel of an aircraft, comprising:
using a first electromechanical braking subsystem to initially move a braking element towards a rotating element associated with said wheel; and
using a piezoelectric braking subsystem to modulate said braking element into contact with said rotating element to thereby effect a braking action on said wheel.

22. The method of claim 21, wherein using said first electromechanical braking subsystem comprises using an electric motor to drive a ball screw subassembly linearly toward said rotating element.

23. The method of claim 22, wherein using a piezoelectric braking subsystem comprises using a piezoelectric element to modulate said braking element at a desired frequency.
